(19) United States
(12) Patent Application Publication
(10) Pub. No.: US 2025/0069602 A1
(43) Pub. Date: Feb. 27, 2025

(54) VOICE RECOGNITION DEVICE, VOICE RECOGNITION METHOD, AND COMPUTER PROGRAM PRODUCT

(71) Applicants: KABUSHIKI KAISHA TOSHIBA, Tokyo (JP); TOSHIBA DIGITAL SOLUTIONS CORPORATION, Kawasaki-shi (JP)

(72) Inventors: Naoki HIRAYAMA, Kawasaki (JP); Yusaku KIKUGAWA, Tokyo (JP)

(73) Assignees: KABUSHIKI KAISHA TOSHIBA, Tokyo (JP); TOSHIBA DIGITAL SOLUTIONS CORPORATION, Kawasaki-shi (JP)

(21) Appl. No.: 18/811,995

(22) Filed: Aug. 22, 2024

(30) Foreign Application Priority Data
Aug. 25, 2023 (JP) 2023-137211

(51) Int. Cl. G10L 17/06; G10L 17/02; G10L 17/04; G10L 17/24

(52) U.S. Cl. CPC G10L 17/06; G10L 17/02; G10L 17/04; G10L 17/24

(57) ABSTRACT

A voice recognition device includes a memory, a voice recognizing unit, an analyzing unit, a clipping unit, an embedding-vector-calculating unit, a similarity-degree-calculating unit, a determining unit, and a device-control unit. The storing unit is for storing a first-speaker embedding-vector of each given registered speaker, and for storing the individual setting of each registered speaker for use in controlling a device. The analyzing unit analyzes an acoustic-signal and extracts a feature-quantity. The clipping unit clips, from the voice-recognition-result, the feature-quantity sequence included in an utterance section. The embedding-vector-calculating unit calculates a second-speaker embedding-vector using the feature-quantity sequence. The similarity-degree-calculating unit calculates one or more similarity degrees for the second-speaker embedding-vector and one or more first speaker embedding-vectors. Based on the registered speaker determined from the similarity degrees and the voice-recognition-result, the device-control unit controls the device according to the individual setting read from the memory.

### CROSS-REFERENCE TO RELATED APPLICATIONS

This application is based upon and claims the benefit of priority from Japanese Patent Application No. 2023-137211, filed on Aug. 25, 2023, the entire contents of which are incorporated herein by reference.

### FIELD

Embodiments described herein relate generally to a voice recognition device, a voice recognition method, and a computer program product.

### BACKGROUND

Conventionally, a voice recognition technology is known for which the voice of only a particular speaker is recognized. For example, as a method for recognizing the voice of only a speaker identified by the given speaker information, there is a technology for which a speaker embedding vector is coupled with the acoustic feature quantity that is input, and learning is performed so as to recognize the voice of only the particular speaker.

However, in the conventional technology, recognizing the voices of particular speakers and controlling the devices according to the identified speakers and the recognized voices are difficult.

### BRIEF DESCRIPTION OF THE DRAWINGS

FIG. 1 is a diagram illustrating an exemplary functional configuration of a voice recognition device according to an embodiment;

FIG. 2 is a diagram illustrating an exemplary functional configuration of an identifying unit according to the embodiment;

FIG. 3A is a flowchart for explaining an exemplary overall flow of speaker registration according to the embodiment;

FIG. 3B is a flowchart for explaining an exemplary detail flow at Step S2 according to the embodiment;

FIG. 4 is a flowchart for explaining an exemplary flow of voice recognition according to the embodiment;

FIG. 5 is a diagram illustrating an exemplary functional configuration of the identifying unit according to a first modification example of the embodiment;

FIG. 6 is a diagram illustrating keyword information according to the first modification example of the embodiment;

FIG. 7 is a diagram illustrating an exemplary functional configuration of a voice recognition device according to a second modification example of the embodiment; and

FIG. 8 is a diagram illustrating an exemplary hardware configuration of the voice recognition device according to the embodiment.

### DETAILED DESCRIPTION

A voice recognition device according to an embodiment includes a memory and one or more hardware processors configured to function as a voice recognizing unit, an analyzing unit, a clipping unit, an embedding vector calculating unit, a similarity degree calculating unit, a determining unit, and a device control unit. The memory that is used to store a first speaker embedding vector of each of one or more given registered speakers, and individual setting of each of the one or more registered speakers for use in controlling a device. The voice recognizing unit recognizes a voice from an acoustic signal and obtains a voice recognition result. The analyzing unit analyzes the acoustic signal and extracts a feature quantity indicating a feature of a waveform of the acoustic signal. The clipping unit clips, from the voice recognition result, a feature-quantity sequence included in an utterance section. The embedding vector calculating unit calculates a second speaker embedding vector using the feature-quantity sequence. The similarity degree calculating unit calculates one or more similarity degrees for the second speaker embedding vector and one or more first speaker embedding vectors. The determining unit determines, based on the one or more similarity degrees, which speaker among the one or more registered speakers utters. The device control unit controls, based on a registered speaker who is determined from the one or more similarity degrees and based on the voice recognition result, the device according to the individual setting read from the memory. An exemplary embodiment of a voice recognition device, a voice recognition method, and a computer program product is described in detail with reference to the accompanying drawings.

In a voice recognition device 100 according to the embodiment, using a speaker embedding model that is learnt independently from a voice recognition model, a speaker embedding vector is calculated for a voice in a section in which a keyword is detected by means of keyword spotting. In the voice recognition device 100 according to the embodiment, speaker identification is performed based on the similarity degree with respect to each preregistered speaker. Then, in the voice recognition device 100 according to the embodiment, based on the detected keyword and based on the result of speaker identification, devices such as an acoustic device and an air-conditioning system are controlled. This enables achieving voice recognition aimed at a plurality of speakers and unique control according to each speaker.

### Exemplary Functional Configuration

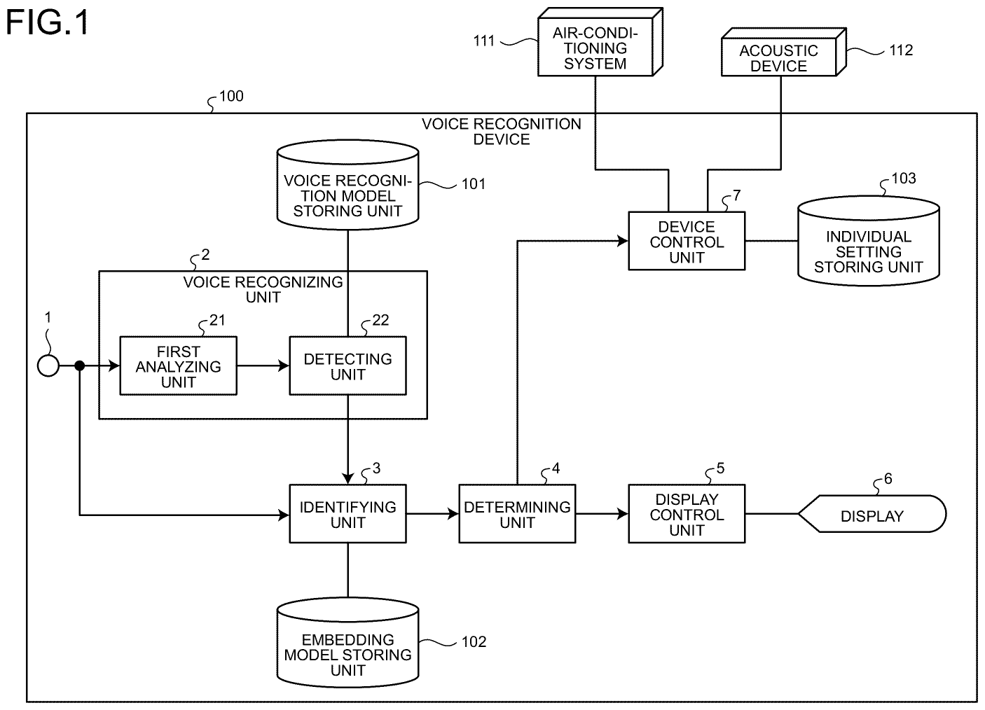

FIG. 1 is a diagram illustrating an exemplary functional configuration of the voice recognition device 100 according to the embodiment. The voice recognition device 100 according to the embodiment includes a microphone 1, a voice recognizing unit 2, an identifying unit 3, a determining unit 4, a display control unit 5, a display 6, and a device control unit 7. The voice recognizing unit 2 further includes a first analyzing unit 21 and a detecting unit 22. The voice recognition device 100 according to the embodiment also includes a voice recognition model storing unit 101, an embedding model storing unit 102, and an individual setting storing unit 103.

The microphone 1 obtains the voices of one or more speakers and inputs, to the first analyzing unit 21 and the identifying unit 3, an acoustic signal obtained at each timing.

The first analyzing unit 21 extracts, from the acoustic signal that is input at each timing from the microphone 1, the feature quantity indicating the feature of the waveform of the acoustic signal. Examples of the extracted feature quantities include the MFCC (Mel-Frequency Cepstrum Coefficients) and the Mel-filterbank feature quantity.

The detecting unit 22 detects a keyword from a feature-quantity sequence and inputs, to the identifying unit 3, keyword information that contains the keyword detection result, the keyword start timing, and the keyword end timing.

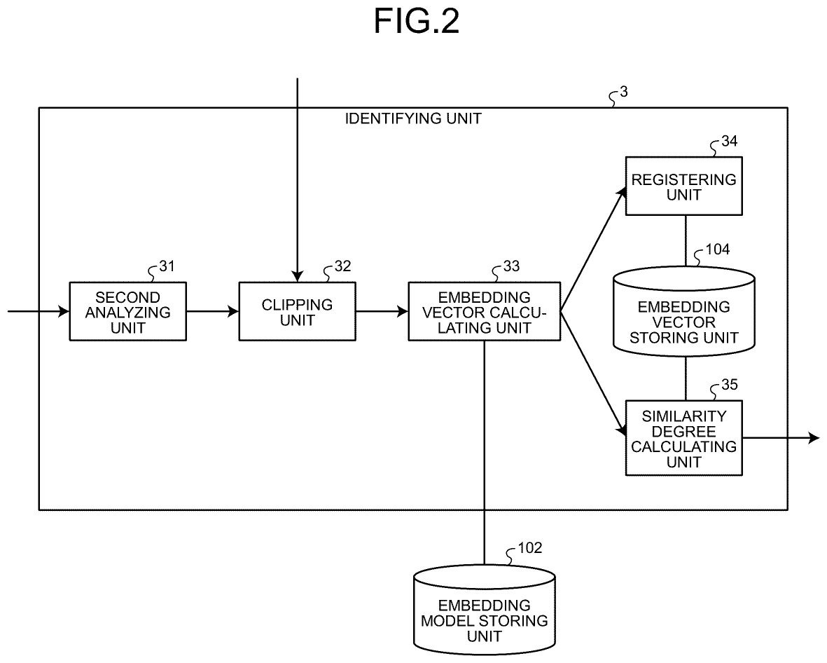

FIG. 2 is a diagram illustrating an exemplary functional configuration of the identifying unit 3 according to the embodiment. The identifying unit 3 according to the embodiment includes a second analyzing unit 31, a clipping unit 32, an embedding vector calculating unit 33, a registering unit 34, a similarity degree calculating unit 35, and an embedding vector storing unit 104.

The second analyzing unit 31 has the feature quantity extraction function in a similar manner to the first analyzing unit 21. The feature quantity extracted by the second analyzing unit 31 can be same as the feature quantity extracted by the first analyzing unit 21. In that case, the identifying unit 3 can receive the feature quantity from the first analyzing unit 21.

The clipping unit 32 receives the feature quantities from the second analyzing unit 31 and receives the keyword information from the detecting unit 22; and clips a feature-quantity sequence included between the keyword start timing and the keyword end timing (i.e., included within the keyword detection section).

The embedding vector calculating unit 33 reads a speaker embedding model from the embedding model storing unit 102 and, based on the speaker embedding model, calculates a speaker embedding vector. As the calculation method for calculating a speaker embedding vector, for example, i-vector, d-vector (refer to Wan et al., Generalized End-to-End Loss for Speaker Verification, ICASSP 2018, pp. 4879-4883, 2018), x-vector (refer to Synder et al., X-Vectors: Robust DNN Embeddings for Speaker Recognition, ICASSP 2018, pp. 5329-5333, 2018), or derived methods of such vectors are usable.

For the voice recognition target (registration target), the registering unit 34 takes the average of a predetermined number of speaker embedding vectors calculated in advance, and stores the averaged speaker embedding vector in the embedding vector storing unit 104.

The similarity degree calculating unit 35 calculates the similarity degree between a speaker embedding vector calculated by the embedding vector calculating unit 33 and the speaker embedding vector of a registered speaker stored in the embedding vector storing unit 104. As the calculation method for calculating the similarity degree, for example, cosine similarity and PLDA (refer to Ioffe, Probabilistic linear discriminant analysis, ECCV Part IV, LNCS 3954, pp. 531-542, 2006) are usable.

Returning to FIG. 1, based on the similarity degrees calculated by the similarity degree calculating unit 35, the determining unit 4 determines the speaker of the utterance included in the keyword detection section, and inputs the determination result (identification result) of the speaker to the display control unit 5 and the device control unit 7.

Based on the determination result input from the determining unit 4, the display control unit 5 displays, in the display 6, the information identifying the speaker whose voice is recognized.

Based on the determination result input from the determining unit 4, the device control unit 7 reads the individual setting of the identified speaker from the individual setting storing unit 103; and controls an air-conditioning system 111 and an acoustic device 112 based on the individual setting.

For example, the device control unit 7 performs device control according to the combination of the speaker identification result and the voice recognition result. Specifically, when the acoustic device 112 is a car audio and when a speaker utters “play my favorite song”, the device control unit 7 plays the favorite song of the speaker as defined by the individual setting. Moreover, for example, when a speaker utters “favorite setting” with respect to the air-conditioning system 111, the device control unit 7 sets the favorite temperature/air volume of the speaker as defined by the individual setting.

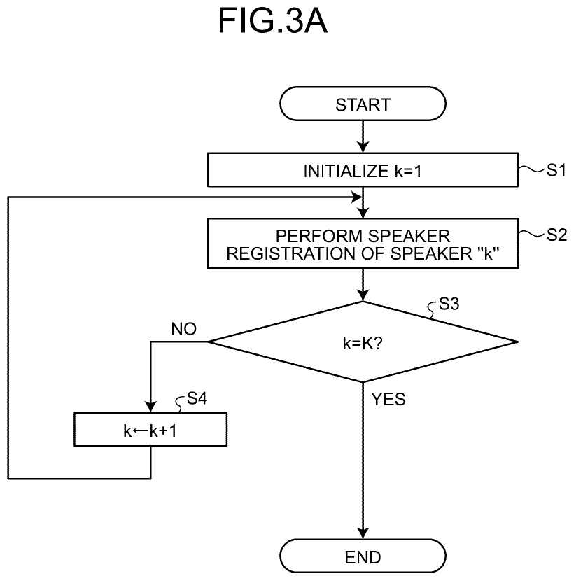

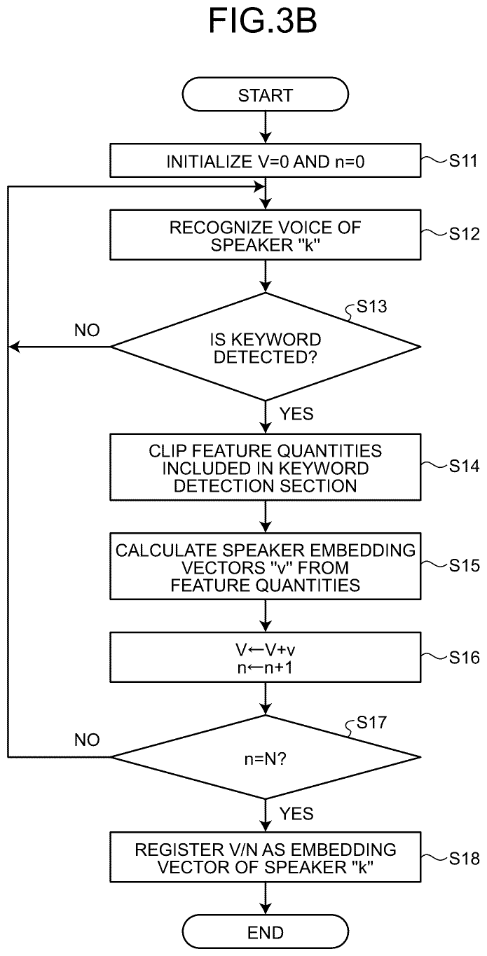

FIG. 3A is a flowchart for explaining an exemplary overall flow of speaker registration according to the embodiment. Firstly, the registering unit 34 initializes a variable “k”, which identifies K number of registration targets, to “1” (Step 51).

Then, the registering unit 34 performs speaker registration of the speaker “k” (Step S2). The detailed flow at Step S2 is explained later with reference to FIG. 3B.

Subsequently, the registering unit 34 determines whether k=K (Step S3). If k=K (Yes at Step S3), the speaker registration operation ends.

On the other hand, if not k=K (No at Step S3), the registering unit 34 increments the value of “k” (Step S4), and the system control of the speaker registration operation returns to Step S2.

FIG. 3B is a flowchart for explaining an exemplary detail flow at Step S2 according to the embodiment. Firstly, the registering unit 34 initializes a vector V and a variable “n”, which are to be used in calculating the average of the speaker embedding vectors, to “0” (Step S11).

Then, the voice recognizing unit 2 recognizes the voice of the speaker “k” (Step S12). Specifically, the first analyzing unit 21 extracts the feature quantity from the acoustic signal of the speaker “k” that is input at each timing from the microphone 1; and the detecting unit 22 attempts to detect a keyword from the feature-quantity sequence.

By performing voice recognition at Step S12, if no keyword is detected (No at Step S13), the system control of the user registration operation returns to Step S12 and voice recognition of the speaker “k” is continued.

On the other hand, by performing voice recognition at Step S12, if a keyword is detected (Yes at Step S13), the clipping unit 32 clips the feature quantities included in the keyword detection section (Step S14).

Next, from the feature quantities clipped at Step S14, the embedding vector calculating unit 33 calculates speaker embedding vectors “v” (Step S15).

Subsequently, the registering unit 34 adds the speaker embedding vector “v”, which is calculated at Step S15, to the vector V, and increments the variable “n” (Step S16). Then, the registering unit 34 determines whether n=N (Step S17). If not n=N (No at Step S17), the system control of the speaker registration operation returns to Step S12 and voice recognition of the speaker “k” is continued.

On the other hand, if n=N (Yes at Step S17), the registering unit 34 divides the vector V by N to calculate the average of the speaker embedding vectors “v” of the speaker “k” calculated at Step S15; and registers, in the embedding vector storing unit 104, the vector V/N as the speaker embedding vector of the speaker “k” (Step S18).

As illustrated in FIG. 3B, for each of the N number of utterances (N≥1) uttered by the same speaker, the registering unit 34 calculates each speaker embedding vector (a first speaker embedding vector). Then, the registering unit 34 registers, as the speaker embedding vector of the same speaker in the embedding vector storing unit 104, a statistic (i.e., statistical quantity which is the average in the example illustrated in FIG. 3B) of each of the speaker embedding vectors. At the time of registration of a speaker, by inputting a plurality of utterances, the variation in the speaker embedding vectors of the utterances made by the speaker can be suppressed.

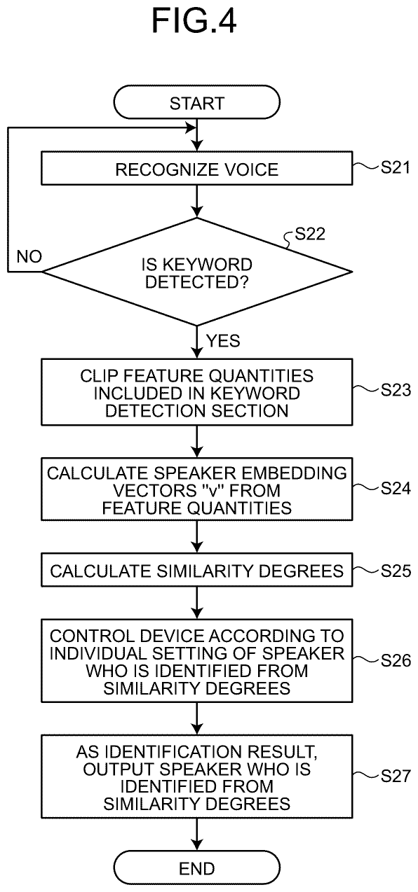

FIG. 4 is a flowchart for explaining an exemplary flow of voice recognition according to the embodiment. Firstly, the voice recognizing unit 2 recognizes the voice input from the microphone 1 (Step S21). Specifically, from the acoustic signal input at each timing from the microphone 1, the first analyzing unit 21 extracts the feature quantity; and the detecting unit 22 attempts to detect a keyword from the extracted feature-quantity sequence.

By performing voice recognition at Step S21, if no keyword is detected (No at Step S22), the system control of the user registration operation returns to Step S21 and voice recognition of the speaker “k” is continued.

On the other hand, by performing voice recognition at Step S21, when a keyword is detected (Yes at Step S22), the clipping unit 32 clips the feature quantities included in the keyword detection section (Step S23).

Then, from the feature quantities clipped at Step S23, the embedding vector calculating unit 33 calculates the speaker embedding vectors “v” (Step S24). Subsequently, the similarity degree calculating unit 35 calculates the similarity degrees of the speaker embedding vectors “v” calculated at Step S24 with the speaker embedding vector of each registered speaker as stored in the embedding vector storing unit 104 by the registering unit 34 (Step S25).

Then, based on the similarity degrees calculated at Step S25, the determining unit 4 determines the speaker of the utterances included in the keyword detection section; and, based on the determination result (identification result) about the speaker, the device control unit 7 controls the devices according to the individual setting of the identified speaker (Step S26).

Subsequently, the display control unit 5 displays, in the display 6, the information identifying the speaker whose voice is recognized at Step S21 (the speaker who is identified from the similarity degree is output as the identification result) (Step S27).

As explained above, in the voice recognition device 100 according to the embodiment, the embedding model storing unit 102 (an exemplary memory) is used to store the first speaker embedding vector of one or more given registered speakers; and the individual setting storing unit 103 (an exemplary memory) is used to store the individual setting of the registered speakers for use in device control. The voice recognizing unit 2 recognizes a voice from an acoustic signal and obtains the voice recognition result. The second analyzing unit 31 analyzes the acoustic signal and extracts the feature quantities indicating the features of the waveform of the acoustic signal. The clipping unit 32 clips, from the voice recognition result, the feature-quantity sequence included in the utterance section. The embedding vector calculating unit 33 calculates a second speaker embedding vector using the feature-quantity sequence. The similarity degree calculating unit 35 calculates one or more similarity degrees for the second speaker embedding vector and one or more first speaker embedding vector. Based on the one or more similarity degrees, the determining unit 4 determines which of the one or more registered speakers has made the utterances. Then, based on the registered speaker who is determined from the one or more similarity degrees and based on the voice recognition result, the device control unit 7 controls the devices according to the individual setting read from the individual setting storing unit 103.

With such a configuration of the voice recognition device 100 according to the embodiment, a speaker embedding model (the first speaker embedding vector(s) of one or more registered speakers) is used that is independent of a voice recognition model meant for use in voice recognition, and voice recognition is performed with respect to a plurality of particular speakers as targets. This enables the voices of a plurality of particular speakers to be recognized and device control to be performed according to the identified speakers and the recognized voices.

Conventionally, because the mechanism is intended to recognize the voice of only a given particular speaker, there is a problem that a plurality of speakers cannot be covered as the target speaker, such as in the case in which the voice of a speaker A and the voice of a speaker B are to be recognized. Moreover, because the voice recognition model is dependent on the speaker embedding model, there is a problem in that tuning the models to fit to the environment becomes complex such as necessitating re-learning of both the models in order to deal with the changes in the environment and the changes occurring over time.

### First Modification Example of Embodiment

Given below is the explanation of a first modification example of the embodiment. In the first modification example, the same explanation as given in the embodiment is not repeated, and only the differences with the embodiment are explained.

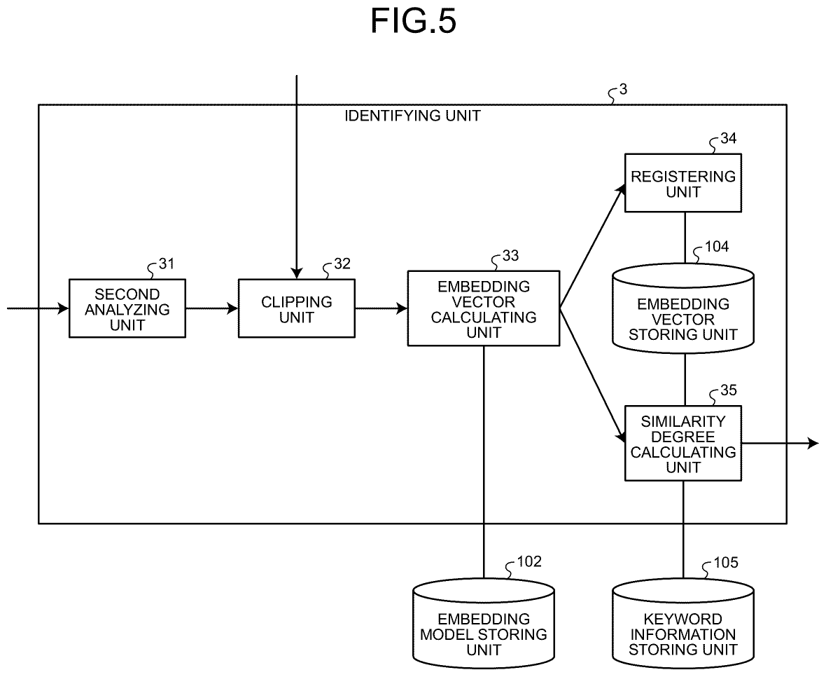

FIG. 5 is a diagram illustrating an exemplary functional configuration of the identifying unit 3 according to the first modification example of the embodiment. In the example illustrated in FIG. 5, the similarity degree calculating unit 35 further reads the keyword information from a keyword information storing unit 105. The keyword information storing unit 105 stores the combinations of the registered speakers and the keywords.

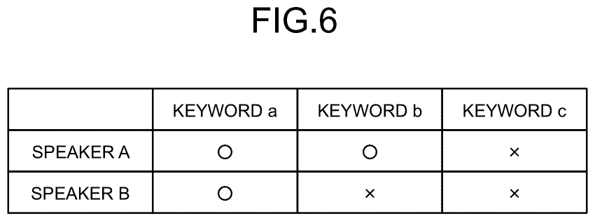

FIG. 6 is a diagram illustrating the keyword information according to the first modification example of the embodiment. In the keyword information according to the first modification example is indicative of a list of receivable keywords for each of the speaker A and the speaker B. For example, it is illustrated that a keyword “b” can be received for the speaker A but cannot be received for the speaker B. Thus, for each speaker, the keyword information is used as the filter for deciding on the receivable keywords.

The similarity degree calculating unit 35 can receive, from the clipping unit 32 via the embedding vector calculating unit 33, a voice recognition result for the keyword detection section, and can calculate the similarity degree only with speakers for whom the voice-recognized keyword is inputtable. That enables achieving reduction in the cost of calculating the similarity degrees.

That is, the similarity degree calculating unit 35 calculates, for the voice recognition result, the similarity degree between each first speaker embedding vector of a registered speaker which includes a receivable keyword as defined in the keyword information illustrated in FIG. 6 and the second speaker embedding vector calculated by the embedding vector calculating unit 33. That is, for the voice recognition result, the similarity degree calculating unit 35 does not calculate the similarity degree between a first speaker embedding vector of a registered speaker which does not include a receivable keyword as defined in the keyword information illustrated in FIG. 6 and the second speaker embedding vector calculated by the embedding vector calculating unit 33.

Moreover, the embedding vector calculating unit 33 can further receive the keyword recognition result from the voice recognizing unit 2 via the clipping unit 32, and can calculate the speaker embedding vectors from the acoustic feature quantities and the keyword recognition result. The keyword recognition result can be in the form of keyword IDs or character strings corresponding to the utterances, or can be in the form of an acoustic score at each timing. Herein, the acoustic score indicates the probability that the voice at each timing corresponds to each phoneme.

In other words, the voice recognition result includes the acoustic score that indicates the probability that the voice at each timing corresponds to each phoneme, and the embedding vector calculating unit 33 can calculate a speaker embedding vector (a second speaker embedding vector) from the acoustic score at each timing and the feature quantity at each timing included in the feature-quantity sequence. With the above features, when the utterance contents at the time of registration are different than the utterance contents at the time of identification, it is expected to have an enhancement in the identification performance.

Meanwhile, based on the threshold value (a first threshold value) of the similarity degree, the determining unit 4 can further determine that the particular utterance is not by any of the registered speakers. In that case, the display control unit 5 displays, in the display 6, the information (such as the names) enabling identification of the registered speakers determined from one or more similarity degrees. When all of the similarity degrees are equal to or smaller than the first threshold value, the information indicating that the reliability of the identification accuracy of the speaker is equal to or smaller than the first threshold value is displayed in the display 6.

Either the threshold value can be a fixed value, or the determining unit 4 can further receive the keyword detection result and a different threshold value can be used according to the keyword detection result.

With the above features, the utterances of the speakers other than the predetermined registered speakers can be rejected. Moreover, when the detecting unit 22 mistakenly responds to non-voice sounds such as an environmental noise and outputs the detection result, such a detection result can be rejected.

Furthermore, if the similarity degree between the input utterance and an already-registered speaker embedding vector is equal to or smaller than a threshold value, it is possible to prompt the speaker to again make the utterance and to reject the mistake in the voice recognition result attributed to the background noise.

### Second Modification Example of Embodiment

Given below is the explanation of a second modification example of the embodiment. In the second modification example, the same explanation as given in the embodiment is not repeated, and only the differences with the embodiment are explained.

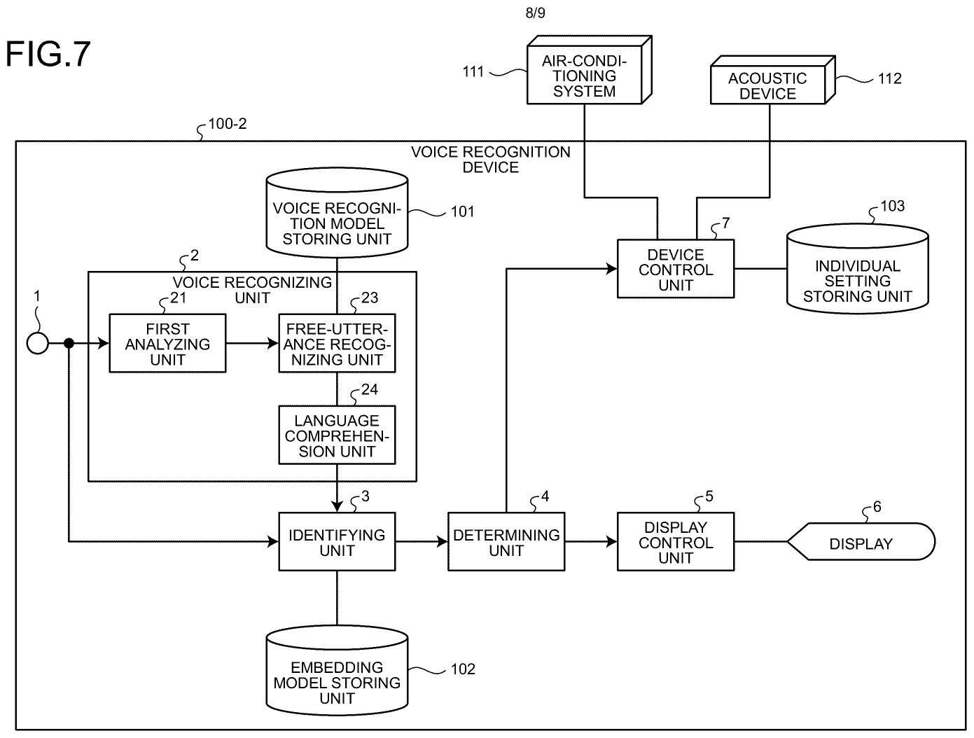

FIG. 7 is a diagram illustrating an exemplary functional configuration of a voice recognition device 100-2 according to the second modification example of the embodiment. In the voice recognizing unit 2 according to the second modification example, a free-utterance recognizing unit 23 and a language comprehension unit 24 are included in place of the detecting unit 22 according to the embodiment.

The free-utterance recognizing unit 23 recognizes the voice of a free utterance not dependent on a predetermined keyword, and converts the voice recognition result into a character string.

The language comprehension unit 24 analyzes the character string obtained by the free-utterance recognizing unit 23. For example, the language comprehension unit 24 obtains, from the character string, the language comprehension result of being comprehended based on a language comprehension model.

The similarity degree calculating unit 35 selects, based on the language comprehension result, one or more first speaker embedding vectors for which the similarity degree is to be calculated; and calculates the similarity degree of the one or more selected first speaker embedding vectors with the second speaker embedding vector calculated by the embedding vector calculating unit 33.

In the configuration illustrated in FIG. 7 according to the second modification example, it also becomes possible to deal with more sophisticated voice input interfaces that are not constrained by particular keywords. By applying speaker identification with respect to large vocabulary speech recognition, it becomes possible to control the operations of the voice interface based on the speaker information, with respect to a wider range of tasks.

For example, in the voice recognition device 100-2 according to the second modification example, in the case of recognizing the utterances of the driver of an automobile and a person sitting next to the driver, from the language comprehension result, the utterances being related to the driving support of the automobile are identifiable. In that case, for example, the similarity degree calculating unit 35 can select, as the target for calculating the similarity degree, the first speaker embedding vector of that registered speaker who is registered as the driver of the automobile.

Meanwhile, at the time of speaker registration, instead of using a fixed number of utterances, the registration can be ended when the dispersion of the speaker embedding vectors of each speaker becomes equal to or smaller than a threshold value. That is, the registering unit 34 can prompt the same speaker to make repeated utterances to calculate each speaker embedding vector (the first speaker embedding vector) for each utterance, and prompt stopping of the utterances when the dispersion of each speaker embedding vector becomes equal to or smaller than a second threshold value.

With the above features, the speaker registration can be performed with the minimal number of utterances, thereby enabling reducing the efforts required in the speaker registration and enhancing the user experience while maintaining the speaker identification accuracy.

Meanwhile, at the time of determination, the values in the embedding vector storing unit 104 can be successively updated using the utterances having the similarity degree to be equal to or greater than a threshold value. Since the voice quality changes over time, if the initially-registered speaker embedding vector is used continuously, the speaker identification accuracy lowers and there are cases of necessitating reregistration. Hence, using the speaker embedding vector having the similarity degree equal to or greater than a threshold value (a third threshold value) (i.e., using the second speaker embedding vector calculated by the embedding vector calculating unit 33), the registering unit 34 can update the embedding vectors of the registered speaker that have the similarity degree equal to or greater than the threshold value (the third threshold value) (i.e., can update the first speaker embedding vectors registered in the embedding vector storing unit 104).

By the successive updating performed by the registering unit 34, it is no more required to periodically perform the explicit reregistration work (for example, the reregistration work at an interval of predetermined years), and the speaker identification accuracy can be maintained also for the elapsed time.

Lastly, the explanation is given about an exemplary hardware configuration of the voice recognition device 100 according to the embodiment.

### Exemplary Hardware Configuration

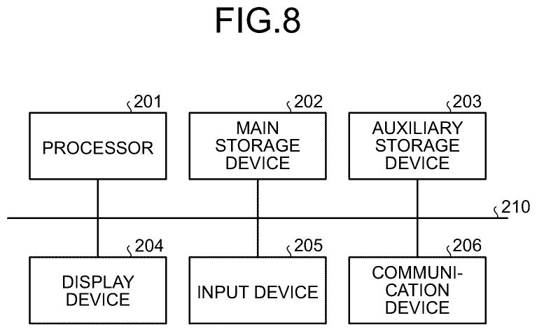

FIG. 8 is a diagram illustrating an exemplary hardware configuration of the voice recognition device 100 according to the embodiment. The voice recognition device 100 according to the embodiment includes a processor 201, a main storage device 202, an auxiliary storage device 203, a display device 204, an input device 205, and a communication device 206. The processor 201, the main storage device 202, the auxiliary storage device 203, the display device 204, the input device 205, and the communication device 206 are connected to each other via a bus 210.

Meanwhile, the voice recognition device 100 need not include some of the abovementioned configuration. For example, when the input function and the display function of an external device are usable, the voice recognition device 100 need not include the display device 204 and the input device 205.

The processor 201 executes a computer program that is read from the auxiliary storage device 203 into the main storage device 202. The main storage device 202 represents a memory such as a read only memory (ROM) or a random access memory (RAM). The auxiliary storage device 203 represents a hard disk drive (HDD) or a memory card.

The display device 204 is, for example, a liquid crystal display (in the example illustrated in FIG. 1, the display 6). The input device 205 represents an interface for operating the voice recognition device 100. Meanwhile, the display device 204 and the input device 205 can alternatively be implemented using a touch-sensitive panel equipped with the display function and the input function. The communication device 206 represents an interface for communicating with other devices.

For example, the computer program executed in the voice recognition device 100 is recorded as an installable file or an executable file in a computer-readable memory medium such as a memory card, a hard disk, a CD-RW, a CD-ROM, a CD-R, a DVD-RAM, or a DVD-R; and is provided as a computer program product.

Alternatively, for example, the computer program executed in the voice recognition device 100 can be stored in a downloadable manner in a computer connected to a network such as the Internet.

Still alternatively, the computer program executed in the voice recognition device 100 can be distributed via a network such as the Internet without involving the downloading task. More particularly, the configuration can be such that the voice recognition operation is performed according to, what is called, an application service provider (ASP) service in which, without transferring the computer program from a server computer, the processing functions are implemented only according to the execution instruction and the result acquisition.

Still alternatively, the computer program executed in the voice recognition device 100 can be stored in advance in a ROM.

The computer program executed in the voice recognition device 100 has a modular configuration that, from among the functional configuration explained above, includes functions implementable also by a computer program. As the actual hardware, the processor 201 reads the computer program from a memory medium and executes the program, so that each aforementioned functional block is loaded in the main storage device 202. That is, each functional block is generated in the main storage device 202.

Some or all of the abovementioned functions can be implemented not by using software but by using hardware such as an integrated circuit (IC).

Moreover, the functions can be implemented using a plurality of the processors 201. In that case, each of the processors 201 can implement one of the functions, or can implement two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A voice recognition device comprising:
a memory that is used to store
a first speaker embedding vector of each of one or more given registered speakers, and
individual setting of each of the one or more registered speakers for use in controlling a device; and
one or more hardware processors configured to function as:
a voice recognizing unit that recognizes a voice from an acoustic signal and obtains a voice recognition result;
an analyzing unit that analyzes the acoustic signal and extracts a feature quantity indicating a feature of a waveform of the acoustic signal;
a clipping unit that, from the voice recognition result, clips a feature-quantity sequence included in an utterance section;
an embedding vector calculating unit that calculates a second speaker embedding vector using the feature-quantity sequence;
a similarity degree calculating unit that calculates one or more similarity degrees for the second speaker embedding vector and one or more first speaker embedding vectors;
a determining unit that, based on the one or more similarity degrees, determines which speaker among the one or more registered speakers utters; and
a device control unit that, based on a registered speaker who is determined from the one or more similarity degrees and based on the voice recognition result, controls the device according to the individual setting read from the memory.

2. The voice recognition device according to claim 1, wherein
the one or more hardware processors are configured to further function as
a display control unit that
displays, in a display device, information identifying the registered speaker who is determined from the one or more similarity degrees, and
when each of the one or more similarity degrees is equal to or smaller than a first threshold value, displays, in the display device, information indicating that a reliability of an identification accuracy of the speaker is equal to or smaller than the first threshold value.

3. The voice recognition device according to claim 1, wherein
the memory further stores therein a combination of the registered speaker and a keyword, and
the similarity degree calculating unit
calculates a similarity degree with a first speaker embedding vector of a registered speaker for whom the keyword is included in the voice recognition result, and
does not calculate the similarity degree with the first speaker embedding vector of a registered speaker for whom the keyword is not included in the voice recognition result.

4. The voice recognition device according to claim 1, wherein
the voice recognizing unit
converts the voice recognition result into a character string, and
further obtains, from the character string, a language comprehension result of being comprehended based on a language comprehension model; and
based on the language comprehension result, the similarity degree calculating unit selects one or more first speaker embedding vectors for which the similarity degree is to be calculated, and calculates one or more similarity degrees with the selected one or more first speaker embedding vectors.

5. The voice recognition device according to claim 1, wherein the one or more hardware processors are configured to further function as a registering unit that registers the one or more first speaker embedding vectors in the memory, and
with respect to N number of utterances by a same speaker where N≥1, the registering unit calculates each first speaker embedding vector and registers, as the first speaker embedding vector of the same speaker, statistic of the each first speaker embedding vector.

6. The voice recognition device according to claim 5, wherein the registering unit
prompts the same speaker to make repeated utterances,
calculates a first speaker embedding vector corresponding to each utterance, and
prompts stopping of utterance when dispersion of the each first speaker embedding vector becomes equal to or smaller than a second threshold value.

7. The voice recognition device according to claim 5, wherein,
using a second speaker embedding vector having the similarity degree to be equal to or greater than a third threshold value, the registering unit updates a first speaker embedding vector having the similarity degree to be equal to or greater than the third threshold value.

8. The voice recognition device according to claim 1, wherein
the voice recognition result includes an acoustic score indicating a probability that a voice at each timing corresponds to each phoneme, and
the embedding vector calculating unit calculates the second speaker embedding vector from the acoustic score at each timing and from a feature quantity at each timing included in the feature-quantity sequence.

9. A voice recognition method implemented by a computer of a voice recognition device, the method comprising:
storing
a first speaker embedding vector of each of one or more given registered speakers, and
individual setting of each of the one or more registered speakers for use in controlling a device;
recognizing a voice from an acoustic signal and obtaining a voice recognition result;
analyzing the acoustic signal and extracting a feature quantity indicating a feature of a waveform of the acoustic signal;
clipping, from the voice recognition result, a feature-quantity sequence included in an utterance section;
calculating a second speaker embedding vector using the feature-quantity sequence;
calculating one or more similarity degrees for the second speaker embedding vector and one or more first speaker embedding vectors;
determining, based on the one or more similarity degrees, which speaker among the one or more registered speakers utters; and
controlling, based on a registered speaker who is determined from the one or more similarity degrees and based on the voice recognition result, the device according to the individual setting read from a memory.

10. A computer program product having a non-transitory computer readable medium including programmed instructions stored thereon, wherein the instructions, when executed by a computer of a voice recognition device including
a memory that is used to store
a first speaker embedding vector of each of one or more given registered speakers, and
individual setting of each of the one or more registered speakers for use in controlling a device, cause the computer to function as:
a voice recognizing unit that recognizes a voice from an acoustic signal and obtains a voice recognition result;
an analyzing unit that analyzes the acoustic signal and extracts a feature quantity indicating a feature of a waveform of the acoustic signal;
a clipping unit that, from the voice recognition result, clips a feature-quantity sequence included in an utterance section;
an embedding vector calculating unit that calculates a second speaker embedding vector using the feature-quantity sequence;
a similarity degree calculating unit that calculates one or more similarity degrees for the second speaker embedding vector and one or more first speaker embedding vectors;
a determining unit that, based on the one or more similarity degrees, determines which speaker among the one or more registered speakers utters; and
a device control unit that, based on a registered speaker who is determined from the one or more similarity degrees and based on the voice recognition result, controls the device according to the individual setting read from the memory.
